(19) United States
(12) Patent Application Publication
(10) Pub. No.: US 2006/0022136 A1
(43) Pub. Date: Feb. 2, 2006

(54) Multiple gas injection system for charged particle beam instruments

(76) Inventor: Thomas M. Moore, Dallas, TX (US)

Correspondence Address: John A. Thomas;L.B. 48, 13355 Noel Road, Dallas, TX, 75240-1518, US

(21) Appl. No.: 11/186,706

(22) Filed: Jul. 21, 2005

Related U.S. Application Data
(60) Provisional application No. 60/592,103, filed on Jul. 29, 2004.

(51) Int. Cl. G21K 7/00

(52) U.S. Cl. 250/309

(57) ABSTRACT

We disclose a gas injection system having at least one crucible, each crucible holding at least one deposition constituent; at least one transfer tube, the number of transfer tubes corresponding to the number of crucibles, each transfer tube being connected to a corresponding crucible. There is at least one metering valve, the number of metering valves corresponding to the number of transfer tubes, each metering valve being connected to a corresponding transfer tube so that the metering valve can measure and adjust vapor flow in the corresponding transfer tube. A sensor is provided capable of sensing reactions between deposition constituents and a focused ion beam A computer is connected to receive the output of the sensor; the computer is also connected to each metering valve to control the operation of the valve, and the computer is programmed to send control signals to each metering valve to control the operation of the valve; the control signals being computed responsive to feedback from the output of the sensor.

### CLAIM OF PRIORITY

This application claims the priority of United States provisional application Ser. No. 60/592,103, filed Jul. 29, 2004 and having the title of “Multiple gas injection system for charged particle beam instruments.”

### TECHNICAL FIELD

This disclosure relates to the removal of specimens inside focused ion-beam (FIB) microscopes and the preparation of specimens for later analysis in the transmission electron microscope (TEM), and apparatus to facilitate these activities.

### BACKGROUND

The use of in-situ lift-out for TEM sample preparation in the dual-beam FIB has become a popular and accepted technique. The in-situ lift-out technique is a series of FIB milling and sample-translation steps used to produce a site-specific specimen for later observation in a TEM or other analytical instrument. Removal of the lift-out sample is typically performed using an internal nano-manipulator in conjunction with the ion-beam assisted chemical vapor deposition (CVD) process available with the FIB tool. A suitable nano-manipulator system is the Omniprobe AutoProbe 200, manufactured by Omniprobe, Inc., of Dallas, Tex. Details on methods of in-situ lift-out may be found in the specifications of U.S. Pat. Nos. 6,420,722 and 6,570,170. These patent specifications are incorporated into this application by reference, but are not admitted to be prior art with respect to the present application by their mention in the background.

Gas chemistries plays an important role in in-situ lift-out. Gas injection in the FIB may be used for etching to speed the milling process, for ion or electron-beam assisted CVD of oxides, metals and other materials, for deposition of protective layers, and for deposition of planarizing material, such as silicon dioxide, to fill holes where lift-out samples have been excised. For a number of reasons, gas injection systems mounted on the wall of the FIB vacuum chamber have become preferred. This offers a safety advantage over injection systems using gas sources or bottled gasses that are external to the FIB vacuum chamber. Chamber-mounted injection systems also permit whole-wafer analysis and can be easily inserted near (within 50 mm) the position where the charged particle beam strikes the sample. After completion of the injection process, the system can be retracted to a safe position for normal FIB sample translation operations.

There are a limited number of appropriate ports on a typical FIB, however, and a growing number of desired accessories and gas chemistries of interest. A chamber-mounted injection system with only one gas source crucible is inefficient. What is needed is a multiple gas source chamber mounted injection system. Not only would the use of existing ports improve, but with a multiple gas source chamber-mounted injection system, a complex and automated process flow, or schedule, involving different gas sources over a timed deposition period is possible. The individual sources could be maintained at different temperatures to maintain the desired vapor pressure in each tube, and ideally, feedback from sensors should be used to adjust the deposition parameters and maintain them within the correct limits.

### SUMMARY

We disclose a gas injection system, comprising at least one crucible, each crucible holding at least one deposition constituent; at least one transfer tube, the number of transfer tubes corresponding to the number of crucibles, each transfer tube being connected to a corresponding crucible. There is at least one metering valve, the number of metering valves corresponding to the number of transfer tubes, each metering valve being connected to a corresponding transfer tube so that the metering valve can measure and adjust vapor flow in the corresponding transfer tube. A sensor is provided capable of sensing reactions between deposition constituents and a focused ion beam A computer is connected to receive the output of the sensor; the computer is also connected to each metering valve to control the operation of the valve, and the computer is programmed to send control signals to each metering valve to control the operation of the valve; the control signals being computed responsive to feedback from the output of the sensor.

### DRAWINGS

FIG. 1 is a side view of a typical embodiment of a multiple gas injection device.

FIG. 2 is a schematic view of the preferred embodiment of the multiple gas-injection system.

FIG. 3 is a flow chart showing the preferred embodiment of the computer program that controls the multiple gas injection system.

FIG. 4 shows schematically the computer control of the system.

### DESCRIPTION

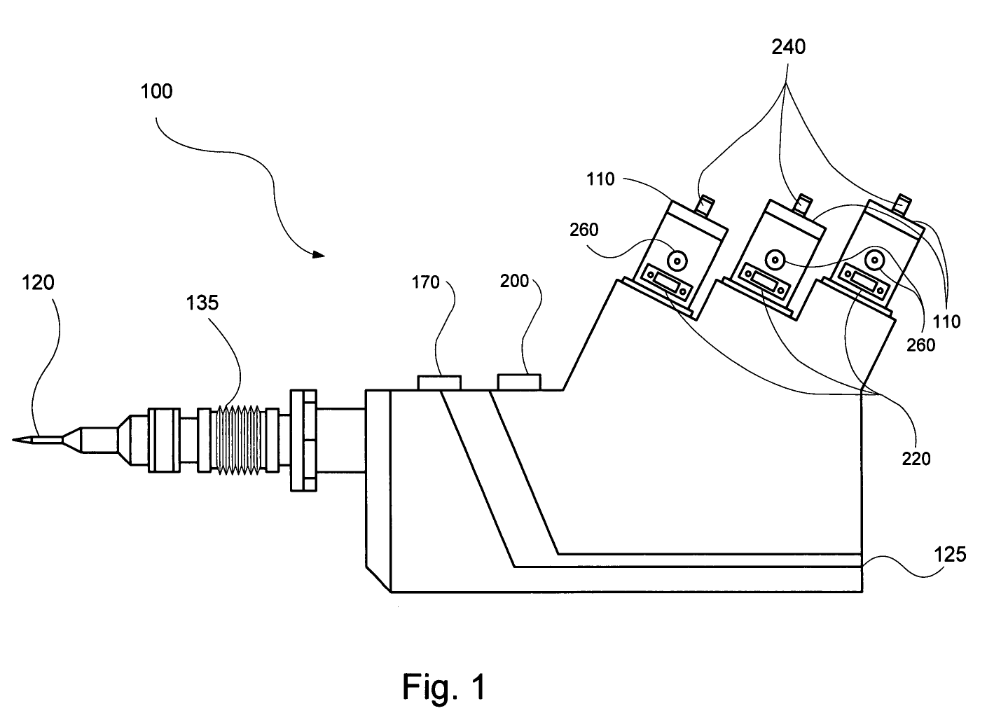

FIG. 1 shows the gas-injection system (100) of the preferred embodiment. A plurality of crucibles (110) contain the gas sources. The crucibles (110) that contains the gas source share the vacuum system with the FIB vacuum chamber. The gasses exit through a single injection tube (120) that is inside the FIB chamber. The system is supported by a housing (125) that seals to the FIB chamber, preferably by a threaded attachment (135). A crucible isolation valve (240) regulates to flow of gas. Although three crucibles (110) are shown in the drawings, the system may have more or fewer.

The crucibles (110) typically hold metal compounds, such as carbonyls metals from the group of Pt or W. When heated, they are vaporized and in the vaporized state they enter the transfer tubes (130).

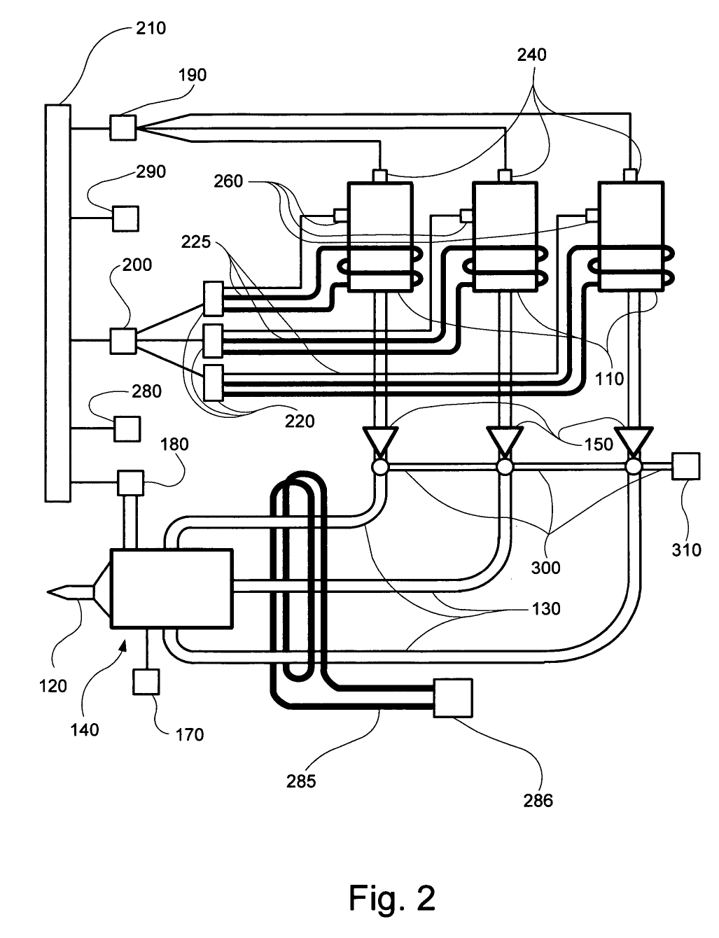

FIG. 2 is a schematic diagram of the preferred embodiment. As shown in FIG. 2, the source gasses pass through independently heated transfer tubes (130) on their way to the final mixing chamber (180) to avoid re-deposition or decomposition in the tubes (130). A carrier or purge gas, such as nitrogen or other inert gas, is metered from metering valves (150) into the transfer tubes (130) to both dilute and carry the source gasses to the final mixing chamber (140). The carrier or purge gas also purges the appropriate transfer tube (130) after a change in the flow program to enable rapid transitions, and to avoid unwanted source gas mixing effects. The source gasses from the transfer tubes (130) are combined in the final mixing chamber (140) before presenting the combination to the sample surface through the single injection tube (120).

Feedback on the flow rates of each source gas and the carrier or purge gas and on the rate of beam-assisted reaction in the FIB is important for proper computer control of the gas injection system.

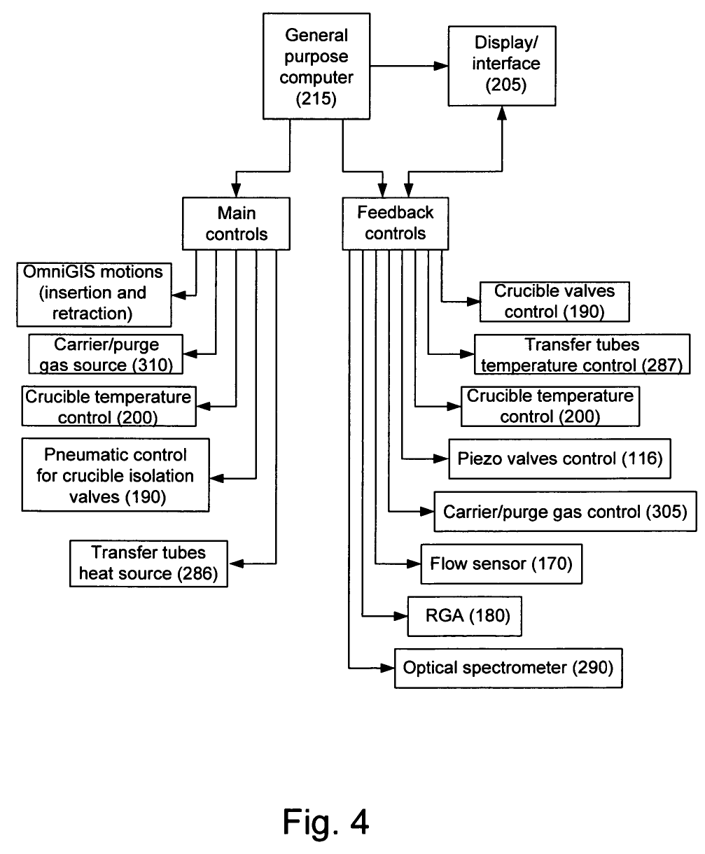

The first level of feedback is a flow sensor (170) connected to the mixing chamber (140). The flow sensor (170) monitors the flow rate of the combined source gas that is injected into the FIB vacuum chamber. In the preferred embodiment, the flow sensor (170) is a diaphragm-type pressure sensor connected to the final mixing chamber (140) which monitors small changes in pressure in the mixing chamber (140). These pressure changes are then converted into flow rates for the combined source gas in a programmed computer (210). The programmed computer (210) will have a central-processing unit, a memory, and storage. The gas injection system (100) can be operated automatically under the control of the computer (210). FIG. 4 shows the connections of the system elements to they computer (210).

The second level of feedback involves detecting the byproducts of the beam-assisted chemical reactions in the FIB, and then using this feedback to adjust the amounts and flow rates of the source gases and carrier gas. In the preferred embodiment, two systems are used for reaction by-product feedback. Both systems can be mounted on the FIB vacuum chamber independently of the system (100), or can be integrated with the gas injection system (100).

The first preferred system for detecting reaction by-products is a Residual Gas Analyzer (RGA) (180) which consists of an ionizer, quadrupole mass filter and a detector. A suitable RGA system is the RGA300 system from Stanford Research Systems, Inc. of Sunnyvale, Calif. Spectra of the residual components in the atmosphere are gathered by the RGA (210) and compared with reference spectra of known beam-assisted reactions in the FIB. From this comparison the relative performance of the reaction can be determined, and adjustments to the flow rates and composition of the combined source gas can be made.

The second preferred system for detecting reaction by-products is an external optical spectrometer (290) attached to the FIB vacuum chamber which uses a diffraction grating to generate a spectrum of the light emissions from the interaction of the charged particle beam, combined source gas and the sample surface. A suitable system is the HR4000 system from Ocean Optics of Dunedin, Fla. This optical spectrum can be compared to reference spectra taken from known interactions of the charged particle beam, specific source gasses and the sample surface. The results of this comparison can be used to make adjustments in the composition and flow rates of the source gasses. A fiber optic cable that transfers the targeted emissions to the spectrometer can be positioned close to the point where the charged particle beam strikes the surface to improve the collection efficiency. This fiber optic cable and the spectrometer can be physically independent of the gas injection system (100), or can be integrated into it.

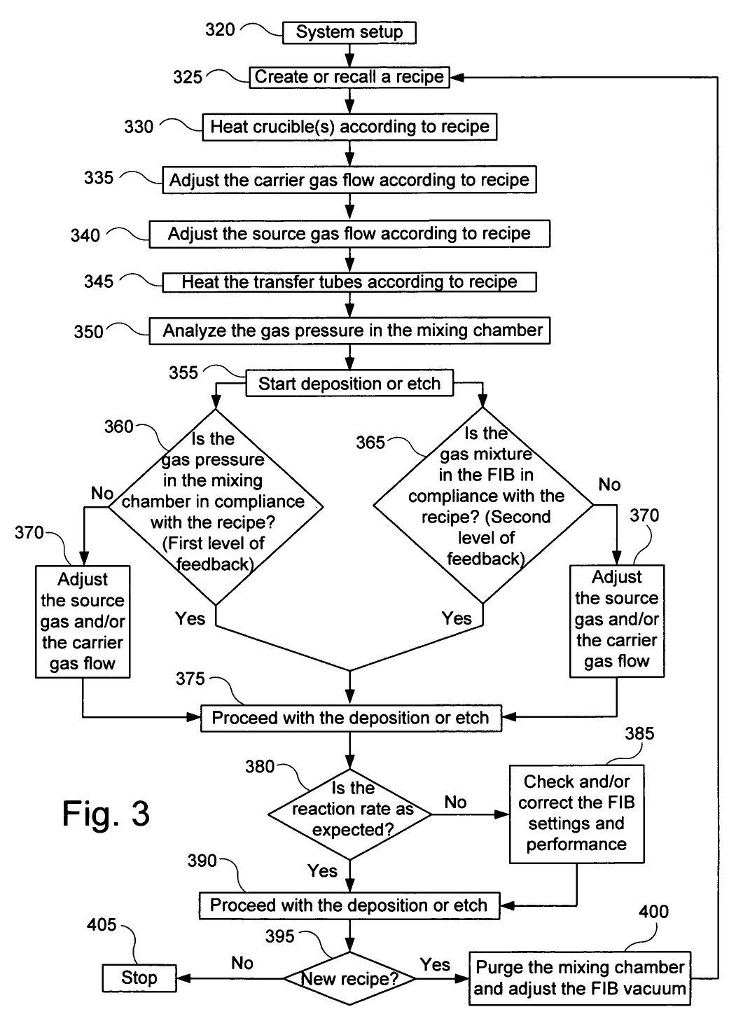

FIG. 3 shows the steps in the program running on the computer (210) of the preferred embodiment. The computer (210) will have machine-readable instructions for carrying out the following steps. At step 320, the program begins. At step 325 the operator either creates a recipe or recalls one from storage. A recipe is a form having editable fields that can be filled in, using a GUI interface executing on the computer (210)> At step 330, the program starts heating the crucibles (110) according to the recipe At step 335 and 340, the program adjusts the carrier gas flow and the source gas flow according to the recipe. At step 345, the transfer tubes (130) are heated according to the recipe. Then, at step 350, the program analyzes the gas pressure in the mixing chamber (140); that is, its pressure is compared to the set of pressure values corresponding to the set of desired gas compositions in the recipe. At this point, the system (100) is ready to begin the operation called for in the recipe, such as deposition or etching (step 355).

Step 360 checks to see if the gas pressure in the mixing chamber (140) is in compliance with the recipe. If it is, execution proceeds to step 375; else, the gas pressure is adjusted to the recipe at step 370, and execution proceeds to step 375. At step 365, the program checks to see if the gas mixture inside the FIB is in compliance with the recipe. If it is, execution proceeds to step 375; else, the flow of source or carrier gas is adjusted to the recipe at step 372, and execution proceeds to step 375. At step 375, the system (100) begins to carry our the selected recipe deposition or etching.

The reaction rate is checked at step 380. If the reaction rate is proceeding as required by the recipe then the procedure continues at step 390; else, at step 385 the program checks for the correct FIB and performance settings and makes necessary corrections. The deposition or etch procedure continues at step 390. After the procedure is complete, the program checks at step 395 for a new recipe to execute. If none is present, then execution stops at 405. Else, step 400 purges the mixing chamber and adjusts the FIB vacuum. Execution then returns to step 325 to repeat the procedures.

FIG. 4 is a schematic diagram showing the gas injection system (100) controlled by the computer (215) and the dedicated external processor (210). The general-purpose computer (215) accomplishes the high-level control over the whole system, including the dedicated external processor (210). At the next level of control, the dedicated external processor (210) controls the carrier gas source (310), the temperature controller (200) for the crucibles (110), the pneumatic controller for the crucible isolation valves (190), and the heat source for the transfer tubes. As part of the feedback system, external processor (210) also controls the residual gas analyzer (180), the optical spectrometer (290) and the flow sensor (170).

I claim:

1. A gas injection system, comprising:
at least one crucible, each crucible holding at least one deposition constituent;
at least one transfer tube, the number of transfer tubes corresponding to the number of crucibles, each transfer tube being connected to a corresponding crucible;
at least one metering valve, the number of metering valves corresponding to the number of transfer tubes, each metering valve being connected to a corresponding transfer tube so that the metering valve can measure and adjust vapor flow in the corresponding transfer tube;
a sensor capable of sensing reactions between deposition constituents and a focused ion beam, the sensor having an output; and
a computer;
the computer connected to receive the output of the sensor;
the computer connected to each metering valve to control the operation of the valve; and,
the computer programmed to send control signals to each metering valve to control the operation of the valve; the control signals being computed responsive to feedback from the output of the sensor.

2. The gas injection system of claim 1, where the sensor is a residual gas analyzer.

3. The gas injection system of claim 1, where the sensor is an external optical spectrometer.

4. The gas injection system of claim 3, where the external optical spectrometer further comprises a fiber optic cable disposed to transfer light emissions from reactions between deposition constituents and a focused ion beam to the spectrometer.

5. The gas injection system of claim 1, further comprising:
at least one transfer tube heat source; the number of transfer tube heat sources corresponding to the number of transfer tubes; each transfer tube heat source being thermally connected to a corresponding transfer tube;
a transfer-tube temperature controller; the transfer-tube temperature controller being connected to each of the transfer tube heat sources;
a transfer-tube temperature sensor for sensing the temperature of the each of the transfer tubes;
the computer connected to receive the output of the transfer-tube temperature sensor;
the computer connected to each transfer-tube temperature controller; and,
the computer programmed to send control signals to each transfer-tube temperature controller, the signals being computed responsive to feedback from the output of the transfer-tube sensor.

6. The gas injection system of claim 1, further comprising:
a purge-gas source;
a purge-gas transfer tube having a source end and at least one termination end, the source end connected to the purge-gas source, the number of termination ends corresponding to the number of transfer tubes, each of the termination ends being connected to the corresponding transfer tube downstream of the corresponding metering valve;
at least one purge-gas metering valve, the purge-gas metering valve being connected to the purge-gas transfer tube so as to enable the purge-gas metering valve to measure and adjust vapor flow in the purge-gas transfer tube;
the computer connected to control each of the purge-gas metering valves.

7. The gas injection system of claim 1, further comprising a mixing chamber; the mixing chamber connected to each of transfer tubes.

8. The gas injection system of claim 7, where the mixing chamber has an injecting tube for injecting mixed gasses from the mixing chamber into the chamber of a focused ion-beam instrument.

9. The gas injection system of claim 1, where the crucibles are removable.

10. A gas injection system, comprising:
at least one crucible; each crucible housing at least one deposition constituent;
a mixing chamber;
at least one transfer tube, the number of transfer tubes corresponding to the number of crucibles, a first end of each the transfer tubes being connected to a corresponding crucible, a second end of each of the transfer tubes being connected to the mixing chamber;
an injection tube for injecting gases into the chamber of a focused ion-beam instrument; the injection tube connected to the mixing chamber;
at least one metering valve; the number of metering valves corresponding to the number of transfer tubes, each metering valve being connected to a corresponding transfer tube so as to enable the metering valve to adjust vapor flow in the corresponding transfer tube;
a computer;
the computer connected to control each metering valve.

11. A gas injection system, comprising:
at least one crucible, each crucible housing at least one deposition constituent;
at least one transfer tube, the number of transfer tubes corresponding to the number of crucibles, each the transfer tubes being connected to a corresponding crucible;
at least one transfer-tube heat source, the number of transfer-tube heat sources corresponding to the number of transfer tubes; each transfer-tube heat source being thermally connected to a corresponding transfer tube;
a transfer-tube temperature controller, the transfer tube temperature controller connected to control each of the at least one transfer tube heat sources;
a computer;
the computer connected to control each transfer-tube temperature controller; and,
the computer connected to control each transfer tube temperature controller.

12. The gas injection system of claim 11, where the crucibles are removable.

13. The gas injection system of claim 11, further comprising:
at least one crucible heat source, the number of crucible heat sources corresponding to the number of crucibles, each crucible heat source being thermally connected to a corresponding crucible;
a crucible temperature controller; the crucible temperature controller connected to control each of the crucible heat sources;
the computer connected to control the crucible temperature controller.

14. The gas injection system of claim 11 further comprising:
at least one metering valve, the number of metering valves corresponding to the number of transfer tubes, each metering valve being connected to a corresponding transfer tube so that the metering valve can adjust vapor flow in the corresponding transfer tube;
a sensor capable of sensing reactions between deposition constituents and a focused ion beam, the sensor having an output; and
the computer connected to receive the output of the sensor;
the computer connected to each metering valve to control the operation of the valve; and,
the computer programmed to send control signals to each metering valve to control the operation of the valve; the control signals being computed responsive to feedback from the output of the sensor.

15. The gas injection system of claim 11, further comprising a mixing chamber; the mixing chamber connected to each of transfer tubes.

16. The gas injection system of claim 15, where the mixing chamber has an injecting tube for injecting mixed gasses from the mixing chamber into the chamber of a focused ion-beam instrument.

17. A gas injection system, comprising:
at least one crucible, each crucible housing at least one deposition constituent;
at least one constituent transfer tube, the number of constituent transfer tubes corresponding to the number of crucibles, each the constituent transfer tubes being connected to a corresponding crucible;
a purge-gas source;
a purge-gas transfer tube having a source end and at least one termination end; the source end being connected to the purge-gas source; the number of termination ends corresponding to the number of purge-gas transfer tubes; each of the termination ends being connected to an intermediate portion of a corresponding constituent transfer tube;
at least one purge-gas metering valve, the number of purge-gas metering valves corresponding to the number of purge-gas transfer tubes; each purge-gas metering valve being connected to a corresponding purge-gas transfer tube so as to enable the purge-gas metering valve to adjust purge gas flow in the corresponding purge-gas transfer tube;
a computer;
where the computer is connected to control each of the at least one purge-gas metering valves.

18. The gas injection system of claim 17, further comprising:
a sensor capable of sensing reactions between deposition constituents and a focused ion beam; the sensor having an output;
the computer connected to receive the output of the sensor;
the computer connected to each constituent metering valve to control the operation of the valve; and,
the computer programmed to control signals to each metering valve to control the operation of the valve; and,
the computer programmed to send control signals to each metering valve to control the operation of the valve; the control signals being computed responsive to feed from the output of the sensor.

19. The gas injection system of claim 18 where the sensor is a residual gas analyzer.

20. The gas injection system of claim 18 where the sensor is an external optical spectrometer.

21. The gas injection system of claim 17 further comprising:
at least one constituent transfer-tube heat source; the number of constituent transfer-tube heat sources corresponding to the number of constituent transfer tubes; each constituent transfer-tube heat source being thermally connected to a corresponding constituent transfer tube;
a constituent transfer-tube temperature controller; the constituent transfer-tube controller being connected to each of the constituent transfer-tube heat sources;
a constituent transfer-tube sensor for sensing the temperature of each of the transfer tubes;
the computer connected to each constituent transfer-tube temperature controller; and,
the computer programmed to send control signals to each constituent transfer-tube temperature controller, the signals being computed responsive to feedback from the output of the constituent transfer-tube sensor.

22. The gas injection system of claim 17, further comprising a mixing chamber; the mixing chamber connected to each of constituent transfer tubes.

23. The gas injection system of claim 22, where the mixing chamber has an injecting tube for injecting mixed gasses from the mixing chamber into the chamber of a focused ion-beam instrument.

24. A method of controlling a gas injection system performing a deposition or etching operation; the gas injection system having at least one crucible for holding a deposition constituent, means for heating and transferring the deposition constituent to a mixing chamber, and means for sensing gas pressure, gas flow, temperature, and reaction rate at a site for deposition or etching; the method comprising the steps of:
creating or recalling a recipe;
heating the crucible according to the recipe;
adjusting carrier gas flow according to the recipe;
heating the means for transferring the deposition constituent according to the recipe;
measuring the gas pressure in the mixing chamber;
determining if the gas pressure in the mixing chamber is in compliance with the recipe; and, if not, adjusting the flow of deposition constituent or carrier gas to bring the gas pressure into compliance with the recipe;
determining if the gas mixture at the operation site is in compliance with the recipe; and, if not, adjusting the flow of deposition constituent or carrier gas to bring the gas mixture at the operation site into compliance with the recipe;
determining if the reaction rate at the operation site is in compliance with the recipe; and, if not, adjusting to bring the reaction rate into compliance with the recipe.
